(19) United States
(12) Patent Application Publication
(10) Pub. No.: US 2007/0257945 A1
(43) Pub. Date: Nov. 8, 2007

(54) Color EL display system with improved resolution

(75) Inventors: Michael E. Miller, Honeoye Falls, NY (US); Michael J. Murdoch, Rochester, NY (US); Ronald S. Cok, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/429,839

(22) Filed: May 8, 2006

(51) Int. Cl. G09G 5/02

(52) U.S. Cl. 345/694

(57) ABSTRACT

A full color electro-luminescent display system, comprising: a display device comprised of a plurality of red, green, blue light-emitting elements and at least one additional color of light-emitting element having luminance efficiency greater than at least one of the red, green and blue light-emitting elements, wherein the light-emitting elements are laid out over a substrate in adjacent columns arranged along a first dimension and adjacent rows arranged along a second dimension, such that each pair of adjacent columns of light-emitting elements, and each row of light-emitting elements, contain each of the red, green, blue and additional color light-emitting elements; and a controller for receiving an input signal for an input image having a two-dimensional spatial content including edge boundaries between first and second regions of the input image and driving the display, the controller being responsive to the two-dimensional spatial content of the input image and increasing apparent display resolution while providing increased display power efficiency.

### FIELD OF THE INVENTION

The present invention relates to color electro-luminescent (EL) display system devices and, more particularly, to arrangements of light-emitting elements and electrical layouts in such color display system devices.

### BACKGROUND OF THE INVENTION

Flat panel, color displays for displaying information, including images, text, and graphics are widely used. These displays may employ any number of known technologies, including liquid crystal light modulators, plasma emission, electro-luminescence (including organic light-emitting diodes), and field emission. Such displays include entertainment devices such as televisions, monitors for interacting with computers, and displays employed in hand-held electronic devices such as cell phones, game consoles, and personal digital assistants. In these displays, the resolution of the display is always a critical element in the performance and usefulness of the display. The resolution of the display specifies the quantity of information that can be usefully shown on the display and the quantity of information directly impacts the usefulness of the electronic devices that employ the display.

However, the term “resolution” is often used or misused to represent any number of quantities. Common misuses of the term include a reference to the number of light-emitting elements or to the number of full-color groupings of light-emitting elements (typically referred to as pixels) as the “resolution” of the display. This number of light-emitting elements is more appropriately referred to as the addressability of the display. Within this document, we will use the term “addressability” to refer to the number of light-emitting elements per unit area of the display device. A more appropriate definition of resolution is to define the size of the smallest element that can be displayed with fidelity on the display. One method of measuring this quantity is to display the narrowest possible, neutral (e.g., white) horizontal or vertical line on a display and to measure the width of this line, or to display an alternating array of neutral and black lines on a display and to measure the period of the smallest alternating pattern having a minimum contrast. Note that using these definitions, as the number of light-emitting elements increases within a given display area, the addressability of the display will increase while the resolution, using this definition, generally decreases. Therefore, counter to the common use of the term “resolution”, the quality of the display is generally improved as the resolution becomes finer in pitch or smaller.

The term “apparent resolution” refers to the perceived resolution of the display as viewed by the user. Although methods for measuring the physical resolution of the display device are typically designed to correlate with apparent resolution, it is important to note that this does not always occur. At least two important conditions exist under which the physical measurement of the display device does not correlate with apparent resolution. The first of these occur when the physical resolution of the display device is small enough that the human visual system is unable to resolve further changes in physical resolution (i.e., the apparent resolution of the display becomes eye-limited). The second condition occurs when the measurement of the physical resolution of the display is performed for only the luminance channel but not performed for resolution of the color information while the display actually has a different resolution within each color channel.

Addressability in most flat-panel displays, especially active-matrix displays, is limited by the need to provide signal busses and electronic control elements in the display. Further, in EL displays, the electronic control elements can be required to share the area that is required for light emission. In these technologies, the more such busses and control elements that are needed, the less area in the display is available for actual light-emitting areas. Further, in such display devices, as the light-emitting area is decreased, the current density required across the EL stack to produce a desired luminance increases and this increase in current density is known to reduce the lifetime of the display device. Therefore, it is important to maintain as large a light-emitting area as possible. Regardless of whether the area required for patterning busses and control elements compete with the light-emitting area of the display, the decrease in bus and control element size that occur with increases in addressability for a given display generally require more accurate, and therefore more complex, manufacturing processes and can result in greater number of defective panels, decreasing yield rate and increasing the cost of marketable displays. Therefore, from a cost and manufacturing complexity point of view, it is generally desirable to provide a display with lower addressability. This desire is, of course, in conflict with the need to provide higher apparent resolution. Therefore, it would be desirable to provide a display that has relatively low addessability but that also provides high apparent resolution.

It should also be noted that other important performance attributes of the EL display device may be influenced by arrangements of light-emitting elements; including the power of the display device and the peak current that any power line within an active matrix EL display needs to deliver to the light-emitting elements to which it provides power. For example, by including white light-emitting elements or broadband light-emitting elements, especially when employing color filters to form RGB light-emitting elements, the power consumption and the current requirements for a typical EL display device can be reduced significantly, as described in US2004/0113875 and US 2005/0212728, both entitled “Color OLED display with improved power efficiency”. The use of such arrangements of light-emitting elements can be employed with drive circuitry as described by U.S. Pat. No. 6,771,028, entitled “Drive circuitry for four-color organic light-emitting device” which discloses several simplified driving means for such arrangements of light-emitting elements. These include, for example, pairs of columns of light-emitting elements, each pair of columns containing four-colors of organic light-emitting devices which share a common electrical bus. The fact that pairs of columns of light-emitting elements share this electrical bus, reduces the area required for electrical bus structures by reducing the number of buses and therefore the area between electrical buses. It is also important to note that when such broad band light-emitting elements are employed, these light-emitting elements will emit light nearer the center of the human photopic sensitivity curve than red and blue light-emitting elements and will therefore be perceived as being high luminance light-emitting elements.

It has been known for many years that the human eye is more sensitive to luminance in a scene than to chrominance. In fact, current understanding of the human visual system includes the fact that processing is performed within or near the retina of the human eye that converts the signal that is generated by the photoreceptors into a luminance signal, a red/green chrominance difference signal and a blue/yellow chrominance difference signal. Each of these three signals have different resolution as depicted by the contrast threshold curves shown in FIG. 1 for a given user population and illumination level. As shown, the luminance channel can resolve the finest detail as indicated by the fact that the contrast threshold curve for the luminance signal 2 has the highest spatial frequency cutoff (i.e., the maximum spatial frequency the eye can resolve at a Michelson contrast of 1 is significantly higher than for the color channels), the contrast threshold for the red/green signal 4 has the second highest spatial frequency cutoff, which is on the order of one half the cutoff for the luminance signal, and the blue/yellow signal 6 has the lowest spatial frequency cutoff.

This difference in sensitivity is well appreciated within the imaging industry and has been employed to provide lower cost systems with high perceived quality within many domains, most notably digital camera sensors and image compression and transmission algorithms. For example, since green light provides the preponderance of luminance information in typical viewing environments because the human visual systems are significantly more sensitive to green light than to red or blue light, digital cameras typically employ two green sensitive elements for every red and blue sensitive element and interpolate intermediate luminance values for the missing colored elements within each color plane as described in U.S. Pat. No. 3,971,065, entitled “Color imaging array”. In typical image compression and transmission algorithms, image signals are converted to a luminance/chrominance representation and the chrominance channels undergo significantly more compression than the luminance channel.

The relative sensitivities of the human eye to different color channels have recently been used in the liquid crystal display (LCD) art to produce displays having subpixels with broad band emission to increase perceived resolution. For example, US Patent Application 2005/0225574 and US Patent Application 2005/0225575, each entitled “Novel subpixel layouts and arrangements for high brightness displays” provide various subpixel arrangements such as the one shown in FIG. 2. FIG. 2 shows a portion of a prior art display 10 as discussed within these disclosures. Of importance in this subpixel arrangement is the existence of a high-luminance (often white or cyan) subpixel 12 that allows more of the white light generated by the LCD backlight to be transmitted to the user than the traditional RGB subpixels (14, 16, and 18) and the fact that each row in the subpixel arrangement contains all colors of subpixels, makes it possible to produce a line of any color using only one row of subpixels. Similarly, every pair of columns within the subpixel arrangement contain all colors of subpixels within the display, making it possible to produce a line of any color using only two columns of subpixels. Therefore, the LCD is driven correctly, it can be argued that the vertical resolution of the device is equal to the height of one row of subpixels and the horizontal resolution of the device is equal to the width of two columns of subpixels, even though it realistically requires more subpixels than the two subpixels at the intersection of such horizontal and vertical lines to produce a full-color image. However, since each pair of subpixels at the junction of such horizontal and vertical lines contain at least one high luminance subpixel (typically green 16 or white 12), each pair of light-emitting elements provide a relatively accurate luminance signal within each pair of subpixels, providing a high-resolution luminance signal.

The drive scheme for such a display is discussed in more detail within US Patent Application 2005/0225563, entitled “Subpixel rendering filters for high brightness subpixel layouts”. As this drive scheme was developed for use in LCD displays, the power consumption of the display is controlled primarily by the backlight brightness, and the addition of broad band subpixels (white, cyan, or yellow) only increase the output luminance of the display device when the light they transmit is used to augment (i.e., is added to) the light that is produced for the RGB subpixels. Therefore, the algorithms that are provided within US Patent Application 2005/0225563 utilizes all colors of subpixels within the display device as much as possible without producing excessive color errors during color rendering. This drive scheme is not desirable for use in an EL display employing a more efficient fourth emitter in combination with RGB emitters, where the maximum efficiency gains that can be achieved are arrived at by turning off the less efficient, narrow transmission band RGB light-emitting elements as much as possible.

More desirable methods for driving an EL displays have been discussed in U.S. Pat. Nos. 6,885,380 and 6,897,876, both entitled “Method for transforming three colors input signals to four or more output signals for a color display” to achieve higher display efficiency has been described. While these methods are analogous to the LCD methods discussed within US Patent Application 2005/0225563, they allow neutral content to be displayed using only the broadband light-emitting elements. If these algorithms designed for obtaining maximum power advantages were to be used together with arrangements of light-emitting elements as described in US Patent Application 2005/0225574 and US Patent Application 2005/0225575, the pixel patterns would not employ the green high-luminance light-emitting element to allow pairs of light-emitting elements to render a high-resolution image and therefore do not provide a method for achieving an optimal tradeoff between EL display power consumption and image quality. U.S. Pat. No. 6,897,876 describes a method for adjusting the use of light-emitting elements near edges within the image signal on a display employing in RGBW stripe patterns, however, an optimal method for using this algorithm in conjunction with pixel patterns such as illustrated in FIG. 2 is not provided.

It is also known to provide an EL display device having pixels with differently sized light-emitting elements, wherein the relative sizes of the elements in a pixel are selected to extend the service life of the display as discussed by U.S. Pat. No. 6,366,025, entitled “Electroluminescence display apparatus”. In particular larger areas of white emitting elements as described in US2004/0113875 may e desirable. Further, such a pixel arrangement would ideally minimize the peak current along an electrical bus within the EL display, increasing the practical aperture ratio of the display device and therefore extending the lifetime of the display device.

There is a need, therefore, for an improved apparatus and method for providing higher apparent resolution, with reduced power consumption and extended lifetime.

### SUMMARY OF THE INVENTION

In accordance with one embodiment, the present invention is directed towards a full color electro-luminescent display system, comprising:

a display device comprised of a plurality of red, green, blue light-emitting elements and at least one additional color of light-emitting element having luminance efficiency greater than at least one of the red, green and blue light-emitting elements, each light-emitting element including a first electrode and a second electrode having one or more electro-luminescent layers formed there-between, at least one electro-luminescent layer being light-emitting, at least one of the electrodes being transparent and the first and second electrodes defining one or more light-emissive areas, wherein the light-emitting elements are laid out over a substrate in adjacent columns arranged along a first dimension and adjacent rows arranged along a second dimension, such that each pair of adjacent columns of light-emitting elements, and each row of light-emitting elements, contain each of the red, green, blue and additional color light-emitting elements; and

a controller for receiving an input signal for an input image having a two-dimensional spatial content including edge boundaries between first and second regions of the input image and driving the display, the controller being responsive to the two-dimensional spatial content of the input image whereby when the additional light-emitting elements are driven at different levels in the first and second regions of the input image, utilization of the light-emitting elements is adjusted such that the ratio of the sum of the luminance values of the red, green, blue light-emitting elements to the sum of the luminance values of the additional light-emitting elements along an edge boundary in at least one of the first and second regions is closer to one than the ratio of the sum of the luminance values of the red, green, blue light-emitting elements to the sum of the luminance values of the additional light-emitting elements within the interior of the at least one of the first and second regions within the displayed image, thereby increasing apparent display resolution while providing increased display power efficiency.

### ADVANTAGES

The advantages of various embodiment of this invention include providing a color display system device with improved apparent resolution, with reduced power consumption and/or extended lifetime.

### BRIEF DESCRIPTION OF THE DRAWINGS

FIG. 1 is a graph depicting the human contrast threshold for luminance and chrominance information (prior art);

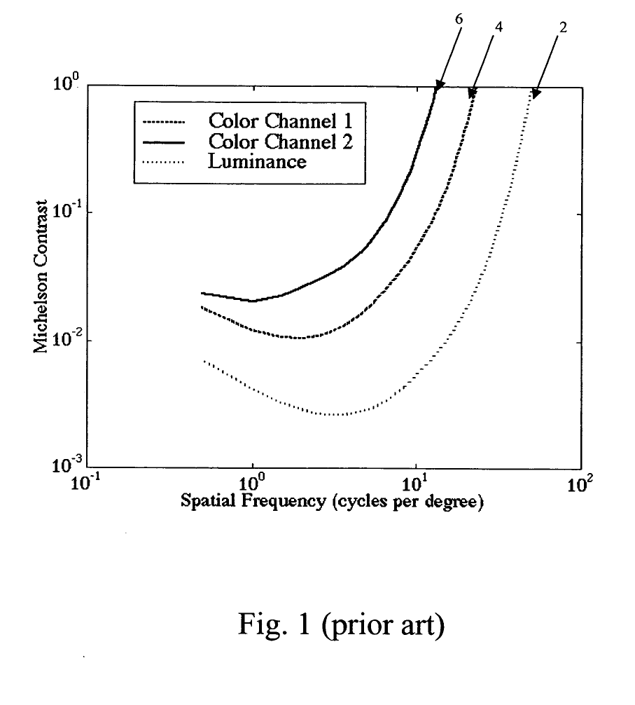

FIG. 2 is a schematic diagram showing the relative arrangement of subpixels within a prior art liquid crystal display disclosure;

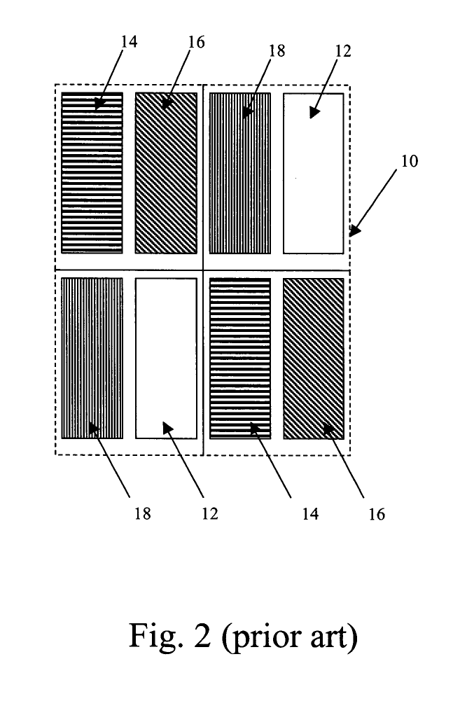

FIG. 3 is a schematic diagram of a portion of an EL display having red, green, blue and white light-emitting display useful in practicing the present invention;

FIG. 4 is a schematic diagram depicting the vertical cross section of a light-emitting element in an EL display useful in practicing the present invention;

FIG. 5 is a diagram depicting the components of the present invention;

FIG. 6 is a flow diagram depicting the processing steps that a controller may perform to enable the present invention;

FIG. 7 is a depiction of a portion of an EL display having the arrangement of light emitting elements as shown in FIG. 3 when rendered using a controller in accordance with an embodiment of the present invention;

FIG. 8 is a schematic diagram of an alternative arrangement of light-emitting elements useful in practicing an embodiment of the present invention, wherein the light-emitting elements include, red, green, blue, white, and an additional colored light-emitting element;

FIG. 9 is a schematic diagram of an alternative arrangement of light-emitting elements useful in practicing an embodiment of the present invention, wherein the light-emitting elements include red, green, blue, yellow and cyan light-emitting elements; and

FIG. 10 is a schematic diagram of an alternative arrangement of light-emitting elements useful in practicing an embodiment of the present invention, wherein the light-emitting elements includes an equal number and area of red, green, and blue light-emitting elements together with a larger number and area of white light-emitting elements.

### DETAILED DESCRIPTION OF THE INVENTION

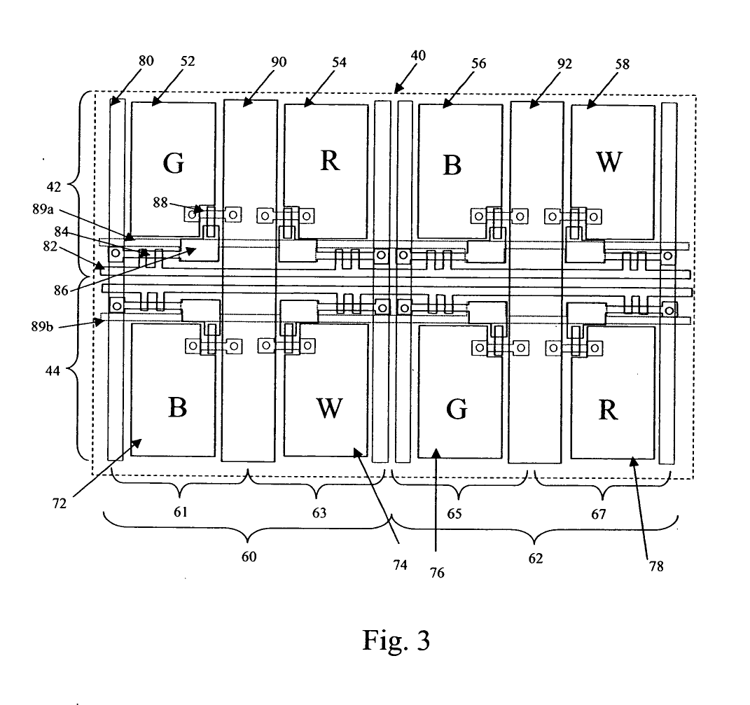

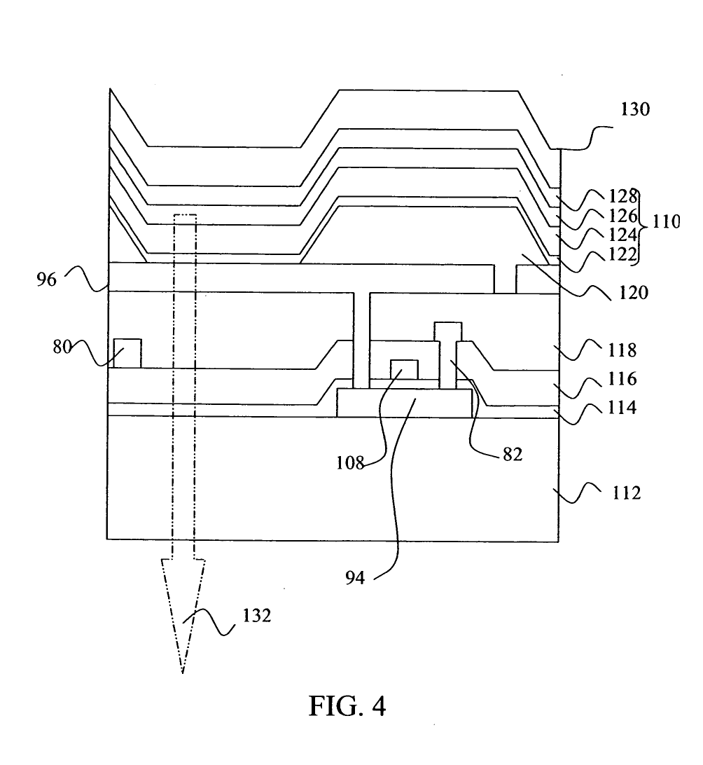

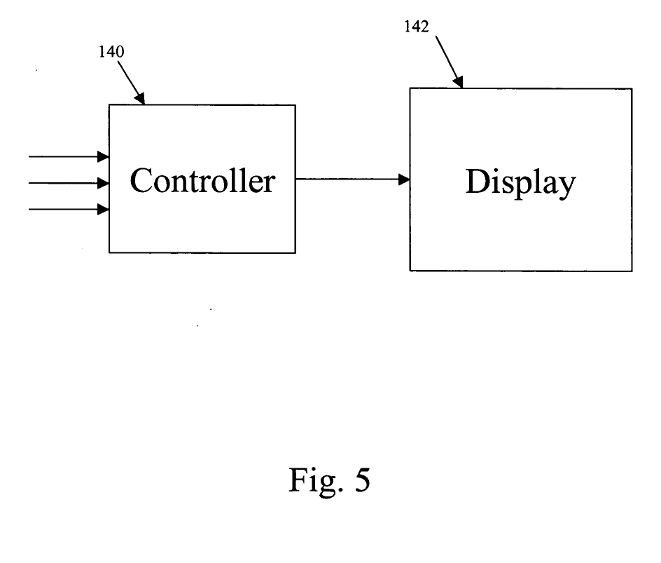

Referring to FIG. 5, full color electro-luminescent display systems in accordance with the invention are comprised of a display device 142 and a controller 140. Referring to FIG. 3, the display device is comprised of a plurality of red 54, 78, green 52, 76, and blue 56, 72 light-emitting elements, and at least one additional 58, 74 color of light-emitting element having luminance efficiency greater than at least one of the red, green and blue light-emitting elements and preferably a luminance efficiency that is greater than the average efficiencies of the red, green and blue light-emitting elements. Referring to FIG. 4, each light-emitting element includes a first electrode 96 and a second electrode 130 having one or more electro-luminescent layers 110 formed there-between, at least one electro-luminescent layer being light-emitting, at least one of the electrodes being transparent and wherein the first and second electrodes defining one or more light-emissive areas. Within this display, the light-emitting elements are laid out over a substrate in adjacent columns 61, 63, 65, 67 arranged along a first dimension and adjacent rows 42, 44 arranged along a second dimension, such that each pair 60, 62 of adjacent columns of light-emitting elements, and each row 42, 44 of light-emitting elements, contain each of the red, green, blue and additional color light-emitting elements.

This arrangement of light-emitting elements allows a luminance pattern to be created such that a white line may be created which is one pair of columns or one row height in width, thereby increasing the potential for higher perceived resolution relative to pixel patterns not employing all colors in each row or pair of columns. However, to reduce the power consumption of the electro-luminescent display while delivering this higher perceived resolution, the display system must further be comprised of a controller for receiving an input signal for an input image having a two-dimensional spatial content (i.e., having edges in two or more relative orientations) and manipulating the input signal such that a four-or-more color signal is created to drive red, green, blue and the one or more additional light-emitting elements wherein the more efficient additional light-emitting elements are preferentially employed over the use of the red, green, and blue light-emitting elements at locations having a relatively low edge strength compared to the use of such light emitting elements at locations having a high edge strength. This may also be expressed as requiring that the ratio of the sum of the luminance values of the red, green, blue light-emitting elements to the sum of the luminance values of the additional light-emitting elements at spatial locations having a relatively high edge strength is closer to one than the ratio of the sum of the luminance values of the red, green, blue light-emitting elements to the sum of the luminance values of the additional light-emitting elements at spatial locations having relatively lower edge strength when provided on the display. Accordingly, when the input signal that is provided to represent an input image having a two-dimensional spatial content that includes edge boundaries between first and second regions is provided to the controller, and the additional light-emitting elements may be driven at different levels in the first and second regions of the input image, and utilization of the light-emitting elements is adjusted such that the ratio of the sum of the luminance values of the red, green, blue light-emitting elements to the sum of the luminance values of the additional light-emitting elements along an edge boundary in at least one of the first and second regions is closer to one than the ratio of the sum of the luminance values of the red, green, blue light-emitting elements to the sum of the luminance values of the additional light-emitting elements within the interior of the at least one of the first and second regions within the displayed image. By providing this control, the controller allows the higher efficiency additional light-emitting element to be utilized in place of the lower efficiency red, green, or blue light-emitting elements for much of the image. However, near high luminance edges, where spatial resolution is particularly necessary, the controller utilizes all of the light-emitting elements to deliver the potential for a higher perceived resolution that is provided by the arrangement of light-emitting elements within the display.

This display system can be particularly advantaged when the light-emitting elements are rectangular in shape, having a longer first dimension than the second dimension, and the input signal that is provided has an addressability (i.e., represents a number of spatial locations) that is larger than the number of full color repeat patterns within the display device. In such a display, the length of the light-emitting elements in the first dimension preferably will be at least 1.5 times the length of the light-emitting elements in the second dimension and the length of light-emitting elements. More preferably, the length of the light-emitting elements in the first dimension will be approximately 2 times the length of the light-emitting elements in the second dimension, and the addressability of the input signal will be equal to half the number of light-emitting elements along the second dimension and equal to the number of light-emitting elements in the first direction. Although the first or second dimension may be laid out to lie on the horizontal, vertical, or any other orientation with respect to the substrate, since there are twice as many light-emitting elements in the second dimension, providing light-emitting elements which have a first dimension that is 2 times their second dimension will provide approximately equal resolution along both dimensions. It might be further recognized that while this invention can be applied for many different display configurations, it will be most valuable for high resolution displays wherein the height of a row is smaller than about 2 minutes of visual angle when viewed by a human observer at the desired or anticipated viewing distance.

This display system can be particularly advantaged when the display device is comprised of an active matrix circuit wherein power is provided by an array of electrical busses since the display will have on the order of half as many light-emitting elements as a display having a conventional pixel layout and with a comparable resolution, and therefore will require substantially fewer active matrix drive circuits than a display of comparable resolution. Additional advantages will be obtained when one or more of the electrical busses provide current to each color of light-emitting elements within the display device. For example, within the full color device each column of a pair of columns of light-emitting elements may be arranged along each side of and may be supplied power by a single electrical buss. Alternatively, pairs of rows of light-emitting elements may be arranged along each side of and may be supplied power by a single electrical buss. This arrangement provides economies by allowing pairs of rows or columns of light-emitting elements, decreasing the number of electrical buses that are required and therefore the space that is required between each of these electrical busses and other patterned elements on the substrate.

In an even more preferred embodiment, the controller may be designed to drive the light-emitting elements of the display device in combination such that the total current requirements of the busses are reduced while the power busses provide power to every color of light-emitting element (i.e., either pairs of columns, individual rows, or pairs of rows). This may be accomplished by controlling the light emissive elements such that the luminance produced by at least one of the light-emitting elements, when all colors of light-emitting elements are employed simultaneously, is lower than the luminance that is produced by the same light-emitting element when the color of light that is being displayed is approximately equal to the color of the light-emitting element. When the light-emitting element is a white light-emitting element, this drive scheme reduces the peak current that each buss is required to provide to a peak current that is on the order of the peak current required to drive two of the four light-emitting elements, reducing the area of the required buss by a factor of a one half and providing room for additional electronics and/or increased area for the light-emitting element. In a bottom-emitting display device, i.e., a device that emits light through the substrate, this embodiment preferably allows the light-emitting area to be increased, thereby lowering the required current density to the light-emitting materials and increasing the lifetime of the display device. Although the at least one additional light-emitting element may be comprised of any color of light-emitting element that has a higher efficiency than at least one of the red, green, or blue light-emitting elements, it will typically preferably be chosen from among white, cyan, yellow, or magenta light-emitting elements.

A detailed embodiment of a portion of a display device useful in practicing this invention is shown in FIG. 3. A portion of a display substrate 40 comprised of red, green, blue and white light-emitting elements is shown, wherein the white light-emitting elements are higher in luminance efficiency than at least one of the red, green, or blue light-emitting elements. Each row, i.e., 42 and 44 of this display device is comprised of all colors of light-emitting elements. For example, the first row 42 of the portion of the display substrate 40 contains red 52, green 54, blue 56 and white 58 light-emitting elements. Additionally, each pair 60 and 62 of columns 61, 63, 65, 67 of light-emitting elements is also comprised of all colors of light-emitting elements. For example, the first pair 60 of columns 61, 63 of light-emitting elements is comprised of green 52, red 54, blue 72, and white 74 light-emitting elements. Also shown in FIG. 3 each light-emitting element is driven by an active matrix circuit, including a select line 82, a data line 80, a select transistor 84, a capacitor 86, a power transistor 88, a power buss 90 and a capacitor line 89a. In this display device, a signal is provided on the select line 82, allowing a drive voltage provided on the data line 80 to charge the capacitor 86. When this capacitor is charged, the power transistor 88 allows current to flow from the power line 90 to a first electrode (not shown), which lies under the light-emitting element 52. The current flows from this electrode through the electro-luminescent material used to form the light-emitting element and to a second electrode above the light-emitting element (also not shown). As shown in this figure, the light-emitting elements in each pair of columns share a common buss. For example, the light-emitting elements (52, 54, 72, and 74) in the first pair 60 of columns, share a common buss 90. Further, the light-emitting elements (56, 58, 76, and 78) in a neighboring pair 62 of columns 65, 67, share a separate, common buss 92.

While FIG. 3 provides a specific configuration of active matrix drive circuitry, several variations of conventional circuits can also be applied to the present invention by those skilled in the art. For instance, the location of the power busses 90 and 92 can be interchanged with capacitor lines 89a and 89b allowing the power lines to provide power to one or even two rows of light-emitting elements.

Another configuration of the drive circuitry, which is described in U.S. Pat. No. 5,550,066, connects the capacitor 86 directly to the power buss 90 instead of a separate capacitor line. A variation in U.S. Pat. No. 6,476,419 uses two capacitors disposed directly over one and another, wherein the first capacitor is fabricated between a semiconductor layer and a gate conductor layer that forms conductor for the gate of one of the TFTs, and the second capacitor is fabricated between the gate conductor layer and a second conductor layer that forms the power buss 90 and data lines 80.

While the drive circuitry described herein requires a select transistor 84 and a power transistor 88, several variations of these transistor designs are known in the art. For example, single- and multi-gate versions of transistors are known and have been applied to select transistors in prior art. A single-gate transistor includes a gate, a source and a drain. An example of the use of a single-gate type of transistor for the select transistor is shown in U.S. Pat. No. 6,429,599. A multi-gate transistor includes at least two gates electrically connected together and therefore a source, a drain, and at least one intermediate source-drain between the gates. An example of the use of a multi-gate type of transistor for the select transistor is shown in U.S. Pat. No. 6,476,419. This type of transistor can be represented in a circuit schematic by a single transistor or by two or more transistors in series in which the gates are connected and the source of one transistor is connected directly to the drain of the next transistor. While the performance of these designs can differ, both types of transistors serve the same function in the circuit and either type can be applied to the present invention by those skilled in the art. The example of the preferred embodiment of the present invention is shown with a multi-gate type select transistor 84.

Also known in the art is the use multiple parallel transistors, which are typically applied to the power transistor 88. Multiple parallel transistors are described in U.S. Pat. No. 6,501,448. Multiple parallel transistors consist of two or more transistors in which their sources are connected together, their drains are connected together, and their gates are connected together. The multiple transistors are separated within the light-emitting elements so as to provide multiple parallel paths for current flow. The use of multiple parallel transistors has the advantage of providing robustness against variability and defects in the semiconductor layer manufacturing process. While the power transistors described in the various embodiments of the present invention are shown as single transistors, multiple parallel transistors can be used by those skilled in the art and are understood to be within the spirit of the invention.

FIG. 4 shows a cross section of one light-emitting element within a bottom-emitting embodiment of such a display. The device including the drive circuitry and the organic EL media 110 are formed on substrate 112. Many materials can be used for substrate 112 such as, for example, glass and plastic. The substrate may be further covered with one or more barrier layers (not shown). If the device is to be operated such that light generated by the light-emitting elements is viewed through the substrate, the substrate should be transparent. This configuration is known as a bottom-emitting device. In this case, materials for the substrate such as glass or transparent plastics are preferred. The aperture ratio of the light-emitting element is particularly important in a bottom-emitting configuration and the improvement of the aperture ratio of the light-emitting elements is a significant advantage of the present invention. This invention may also be utilized in top-emitting display devices, however, wherein the light is emitted away from the substrate. Under these conditions, the substrate may be glass or plastic but may also be formed from opaque materials, such as stainless steel with an insulating layer.

Above the substrate 112, a first semiconductor layer is provided, from which semiconductor region 94 is formed. Above semiconductor region 94, first dielectric layer 114 is formed and patterned by methods such as photolithography and etching. This dielectric layer is preferably silicon dioxide, silicon nitride, or a combination thereof. It may also be formed from several sub-layers of dielectric material. Above first dielectric layer 114, a first conductor layer is provided, from which power transistor gate 108 is formed and patterned by methods such as photolithography and etching. This conductor layer can be, for example, a metal such as Cr, as is known in the art. Above power transistor gate 108, a second dielectric layer 116 is formed. This dielectric layer can be, for example, silicon dioxide, silicon nitride, or a combination thereof. Above second dielectric layer 116, a second conductor layer is provided, from which power buss 90 and data line 80 are formed and patterned by methods such as photolithography and etching. This conductor layer can be, for example, a metal such as an Al alloy as is known in the art. Power buss 90 makes electrical contact with semiconductor region 92 through a via opened in the dielectric layers. Over the second conductor layer, a third dielectric layer 118 is formed.

Above the third dielectric layer, a first electrode 96 is formed. First electrode 96 is preferably highly transparent for the case of a bottom-emitting configuration and may be constructed of a material such as ITO. Above first electrode 96, an inter-subpixel dielectric 120 layer, such as is described in U.S. Pat. No. 6,246,179, is preferably used to cover the edges of the first electrodes in order to prevent shorts or strong electric fields in this area. While use of the inter-subpixel dielectric 120 layer is preferred, it is not required for successful implementation of the present invention. The area of the first electrode 96 not covered by inter-subpixel dielectric 120 constitutes the light-emitting area.

Each of the light-emitting elements further includes an EL media 110. There are numerous configurations of the EL media 110 layers wherein the present invention can be successfully practiced. For example, the EL media may be an organic EL media. For the organic EL media, a broadband or white light source, which emits light at the wavelengths used by all the light-emitting elements, may be used to avoid the need for patterning the organic EL media between light-emitting elements. In this case, color filters (not shown) may be provided for some of the light-emitting elements in the path of the light to produce the desired light colors from the white or broadband emission for a multi-color display. It should be noted that in this configuration, the filters applied to the red, green, and blue light-emitting elements will typically absorb more light than broader bandwidth filters that can be used to form cyan, yellow, or magenta light-emitting elements and certainly will absorb more light than would be absorbed in the absence of a filter. Therefore, in these configurations, it is highly likely that the additional light-emitting elements will have efficiencies that are greater than at least one, if not all three, of the red, green, and blue light-emitting elements. Some examples of organic EL media layers that emit broadband or white light are described, for example, in U.S. Pat. No. 6,696,177B1. However, the present invention can also be made to work where each light-emitting elements has one or more of the organic EL media layers separately patterned for each light-emitting elements to emit differing colors for specific light-emitting elements. The EL media 110 may be constructed of several organic layers such as; a hole injecting layer 122, a hole transporting layer 124 that is disposed over the hole injecting layer 122, a light-emitting layer 126 disposed over the hole transporting layer 124, and an electron transporting layer 128 disposed over the light-emitting layer 126. Alternate constructions of the organic EL media 110 having fewer or more layers can also be used to successfully practice the present invention. These organic EL media layers are typically comprised of organic materials, either small molecule or polymer materials, as is known in the art. These organic EL media layers can be deposited by several methods known in the art such as, for example, thermal evaporation in a vacuum chamber, laser transfer from a donor substrate, or deposition from a solvent by use of an ink jet print apparatus.

Above the EL media 110, a second electrode 130 is formed. For a bottom emitting device, this electrode is preferably highly reflective and may be composed of a metal such as aluminum or silver or magnesium silver alloy. The second electrode may also comprise an electron injecting layer (not shown) composed of a material such as lithium to aid in the injection of electrons. When stimulated by an electrical current between first electrode 96 and second electrode 130, the organic EL media 110 produces light emission 132.

Most OLED devices are sensitive to moisture or oxygen, or both, so they are commonly sealed in an inert atmosphere such as nitrogen or argon, along with a desiccant such as alumina, bauxite, calcium sulfate, clays, silica gel, zeolites, alkaline metal oxides, alkaline earth metal oxides, sulfates, or metal halides and perchlorates. Methods for encapsulation and desiccation include, but are not limited to, those described in U.S. Pat. No. 6,226,890. In addition, barrier layers such as SiOx, Teflon, and alternating inorganic/polymeric layers are known in the art for encapsulation.

EL devices of this invention can employ various well-known optical effects in order to enhance the displays properties if desired. This includes but is not limited to optimizing layer thicknesses to yield maximum light transmission, providing dielectric mirror structures, replacing reflective electrodes with light-absorbing electrodes, providing light scattering layers to enhance light extraction, providing anti-glare or anti-reflection coatings over the display, providing a polarizing media over the display, or providing colored, neutral density, or color conversion filters over the display.

The current invention requires that a display such as described in FIG. 3 and FIG. 4, be provided in a system. FIG. 5 depicts the system of the present invention. As shown in FIG. 5, the system is comprised of a controller 140 and a display 142. Within this system, the controller will receive an input signal, which will generally represent each spatial location with a three-color signal. This color signal may be a RGB signal or it may have a different encoding, such as a luma-chroma encoding. This data will generally be clocked into the controller such that three-color data representing information to be presented in the top left of the display will be transmitted first, followed by information to be presented horizontally across the display, followed subsequently by the data for the beginning of a second horizontal scan across the display, and so forth. As such, it will be necessary for the controller to store information into some form of a memory buffer to gain access to the two-dimensional information that is necessary to perform the functions that are necessary to enable the system of the invention. Therefore, this controller will receive this signal, buffer at least a portion of the signal, transform the signal to a signal for driving the display, and transmit a transformed signal to the display 142. In a preferred embodiment, the controller will buffer at least one line of data. However, in a further preferred embodiment, the controller will buffer 4 lines and 4 pixels of data and then begin processing the data in real-time such that a value is provided to the display after only a slight initial delay. However, it will be recognized that to practice this invention the controller will need access to data representing a spatial location that is horizontally displaced and data representing a spatial location that is vertically displaced from the one that is being processed and preferably, the controller will have access to data for one or two spatial locations that are displaced from the current light-emitting element in all directions.

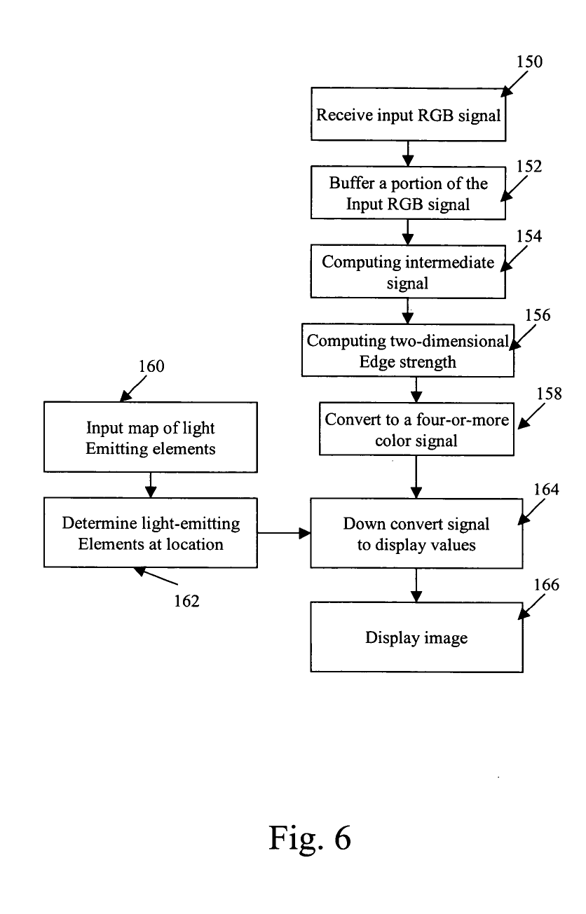

Although, the controller 140 may utilize many different processes to achieve the present invention, this controller will preferably perform the steps as shown in FIG. 6. As shown, the controller will receive 150 an input RGB signal and buffer 152 at least a portion of this signal. Note that the number of spatial locations that are represented in the signal (i.e., the signal addressability) will preferably be larger than the number of any color of light-emitting element on the display device. For example, when displaying an image on the display device depicted in FIG. 3, the number of addressable spatial locations in the signal will preferably be at least one half the number of light-emitting elements within the display device, rather than one fourth of the number of light-emitting elements as is typically taught within the art for a display having four colors of light-emitting elements. The controller will then compute 154 an intermediate signal that is indicative of the luminance output that might be provided by the one or more additional light-emitting elements. Although this computation 154 may take many forms, it may consist of transforming the input RGB values to linear intensity values as is known in the art, computing the RGB intensity values that are necessary to form the color of light that is output by one of the additional light-emitting elements, and then determining the minimum of the of these RGB intensity values. These steps have been described more fully in U.S. Pat. No. 6,885,380, the disclosure of which is hereby incorporated by reference, as steps for forming a white signal in an emissive display system having more than three colors of light-emitting elements. In a system having an additional primary that emits white light another potential intermediate metric is to compute the relative luminance. This value will generally be computed by computing a weighted average of the RGB values. For example, relative luminance might be computed summing 0.3 times the red value plus 0.586 times the green value plus 0.114 times the blue value.

Once the intermediate metric has been computed 154, two-dimensional filtering operations are performed given the current spatial location that is being operated on and at least one of its neighbors in the horizontal or vertical direction to compute 156 the two-dimensional edge strength of the intermediate signal. Although this may be accomplished through a number of means, one desirable method is to compute the ratio of a high pass filtered version of this intermediate signal to a low pass filtered version of the intermediate signal over a two-dimensional area. For example, given the intermediate value p(i,j), which represents the value of the intermediate signal at column i and row j within the image, this two-dimensional signal may be computed as:

$$f ( i , j ) = ( 1 / 9 ) * \frac{{\sum }_{k = i - 1}^{k = i + 1} ( {\sum }_{l = j - 1}^{l = j + 1} ( p ( i , j ) - p ( k , l ) ) )}{{\sum }_{k = i - 1}^{k = i + 1} ( {\sum }_{l = j - 1}^{l = j + 1} ( p ( i , j ) + p ( k , l ) ) ) }$$

where f(i, j) represents the two-dimensional edge strength, the numerator represents the high pass filter and the denominator represents the low pass filter and the factor 1/9 normalizes the resulting values between 0 and 1.

Once the two-dimensional edge strength is computed 156, this edge strength is used to convert 158 the three color input signal to a four-or-more color signal. This computation will typically involve the subtraction of a proportion of energy from the three color input signal and addition of this energy to the one or more additional color channels such that a larger proportion of this energy is moved to the additional color channels when the edge strength is low than when the edge strength is high. As a specific example, returning to step 154, recall that the input three color signal RGB values were converted to linear intensity and then these linear intensity values were normalized to the color of the additional light-emitting element. Returning to these normalized linear intensity values, and the minimum of these values that were computed in step 154, we may compute the normalized output RGB values as
Rₙ(i,j)=Rᵢ(i,j)−a(i,j)*min(Rᵢ(i,j),Gᵢ(i,j),Bᵢ(i,j)), (eqn. 1)
Gₙ(i,j)=Gᵢ(i,j)−a(i,j)*min(Rᵢ(i,j),Gᵢ(i,j),Bᵢ(i,j)), (eqn. 2)
Bₙ(i,j)=Bᵢ(i,j)−a(i,j)*min(Rᵢ(i,j),Gᵢ(i,j),Bᵢ(i,j)) (eqn. 3)

where Rₙ(i,j), Gₙ(i,j), Bₙ(i,j) represent the normalized output values, the values Rᵢ(i,j), Gᵢ(i,j), and Bᵢ(i,j) represent the normalized linear intensity values that were computed from the input signal, and min(Rᵢ(i,j), Gᵢ(i,j), Bᵢ(i,j)) represents the minimum of the normalized linear intensity values. The signal for the additional color channel is then computed as:
Wₙ(i,j)=b(i,j)*min(Rᵢ(i,j),Gᵢ(i,j),Bᵢ(i,j)) (eqn. 4)

where Wₙ(i,j) is the normalized signal for the additional color channel. Note that each of these equations contain the values a(i,j) or b(i,j). In the current embodiment of the present invention a(i,j) and b(i,j) are not constants but instead are functions of the two-dimensional edge strength f(i,j). A simple function that can be employed with success is to compute a(i,j) and b(i,j) as 0.5*(1−f(i,j)). Using this calculation, a white light-emitting element on a black and white edge produce about half the luminance while on the bright side of the edge while the R, G, and B light-emitting elements will produce the remainder. Note that to maintain color accuracy a(i,j) and b(i,j) will be equal but this is not necessary and, in fact, under some circumstances it may be desirable for b(i,j) to have a higher slope than a(i,j). Within this particular implementation, when presenting flat white areas within the scene, the white light-emitting element will produce all of the luminance but the red, green, and blue light-emitting elements will be activated near edge boundaries, even when rendering a black and white scene. Modifications to this process may be made, one such modification is to filter or smooth the edge strength f(i,j) before computing the values of a(i,j) or b(i,j). Finally the weighting of the RGB signals may be modified to normalize them to the white point of the display, thus completing the conversion of the three color input signal to the more than three color signal. If there are more than four colors of light-emitting elements, other modifications may be made to this image processing path. In one implementation, each additional light-emitting element is added to the path one at a time. A step is added between each iteration of the conversion wherein it is determined where in color space each additional light-emitting element lies with respect to the light-emitting elements for which a signal has been computed. Generally, the location of this element will lie within one of the resulting triangles (i.e., subgamuts) formed by the previously added additional light-emitting elements and two of the red, green, and blue light-emitting elements, in subsequent cycles, the three light-emitting elements whose colors define the subgamut in which the additional light-emitting element lies are used in place of the RGB input signals. This process was also described in more detail within U.S. Pat. No. 6,885,380.

It might be noted that one important aspect of the conversion equations 1 through 4 is that luminance is subtracted from the red, green, and blue normalized linear intensity values when forming the information for the one or more light emitting elements and that the value of b(i,j) is not significantly larger than a(i,j) as this has the implication all of the light emitting elements will not be driven to their peak luminance simultaneously, and, therefore, the current that must be provided by any power buss that provides energy to all colors of light emitting elements is less than the peak current that would be provided if all four light-emitting elements were simultaneously driven to their maximum values. Therefore, a controller employing these equations will drive the light-emitting elements of the display device in combination to reduce the total instantaneous current requirements of the busses by controlling the light emissive elements such that the luminance produced by at least one of the light-emitting elements, when all colors of light-emitting elements are employed simultaneously, is lower than the luminance that is produced by the same light-emitting element when the color of light that is being displayed is approximately equal to the color of the light-emitting element. This behavior reduces the peak current that each buss is required to provide, thereby decreasing the required size of the buss and reducing the area required for drive electronics. In a bottom emitting display device, this increases the area available for light emission and in a top emitting display device, this can allow the designer to increase the addressability of the display device.

Once the four-or-more color signal has been formed 158, it is then necessary to determine the output values to drive the display. However, because the arrangement of light-emitting elements on the display varies as a function of spatial location, an input map of the light-emitting elements must be input 160. This map is used to determine 162 the color of light-emitting elements for each addressable data point within the converted four-or-more color image signal. Once the colors of the light-emitting elements are determined 162, the converted four-or-more color signal is down converted 164 to the array of light-emitting elements on the display. For example, referring again to FIG. 3, a spatial location within the four-or-more color signal may correspond to the location on the display comprised of green 52 and red 54 light-emitting elements. For this location, the green and red values may be extracted from the converted four-or-more color signal. These values may be used to drive these light-emitting elements or they may be a weighted fraction of their neighbors. In one embodiment, the current values of the red and green light-emitting elements may be computed as a weighted average of the values at the current location within the converted more than three color signal, wherein the red and green data values at the current location within the signal are weighted equally to the sum of the four neighboring red and green values for which the display does not have light-emitting elements. That is, the value for the green light-emitting element may be computed from:

$${G}_{o } ( i , j ) = \frac{( 4 G ( i , j ) + G ( ( i - 1 ) , j ) + G ( ( i + 1 ) , j ) + G ( i , ( j - 1 ) ) + G ( i , ( j + 1 ) ) )}{8} \qquad ( eqn . 5 )$$

Where Gₒ(i,j) represents the down converted green value for the light-emitting elements at (i,j) where i represents the number of light-emitting elements from the top of the display, j represents the number of rows of light-emitting elements divided by 2 and G(i,j) represents the converted more than color image signal at input addressable element location (i,j).

A fully digital converter would perform this digital down conversion in total. However, the controller may also have analog outputs. In such systems, while down conversion would typically be performed along both dimensions, the down conversion must only be performed in the vertical direction. Horizontal down conversion will be accomplished as the timing controller selects the voltage in the analog signal to be loaded onto the data line 80 of the display device.

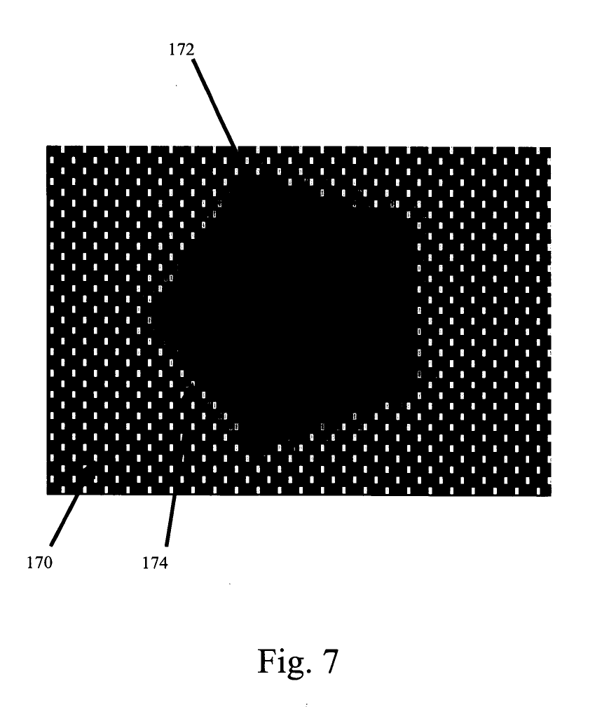

As noted earlier, when such a controller is used in conjunction with a display of the present invention, the controller will receive an input signal for an input image having a two-dimensional spatial content including edge boundaries between first and second regions of the input image and driving the display and then being responsive to the two-dimensional spatial content of the input image, the controller will render the input image signal such that when the additional light-emitting elements are driven at different levels in the first and second regions of the input image, utilization of the light-emitting elements is adjusted such that the ratio of the sum of the luminance values of the red, green, blue light-emitting elements to the sum of the luminance values of the additional light-emitting elements along an edge boundary in at least one of the first and second regions is closer to one than the ratio of the sum of the luminance values of the red, green, blue light-emitting elements to the sum of the luminance values of the additional light-emitting elements within the interior of at least one of the first and second regions within the displayed image. This is depicted in FIG. 7, which shows a portion of such a display containing a displayed image. As shown in this figure, the image is comprised of the first region 170, which is a white background. On this background is a pentagon, which represents the second region 172. As shown in this figure, within areas of the first region that are remote from the second region, practically all luminance is produced by the white light-emitting elements. Therefore, the ratio of the luminance of the sum of the red, green and blue light-emitting elements to the sum of the luminance of the luminance of the red, green, and blue light-emitting elements is approximately zero within the first region. However, near the boundary 174 of the first 170 and second 172 regions, the red, green, and blue light-emitting elements are enabled to improve the smoothness of the edge between the two regions and to thereby improve the perceived resolution of the display device. In fact, in the area near the boundary 174, the ratio of the sum of the luminance values for the red, green, and blue light-emitting elements is approximately equal to the luminance value of the additional white light-emitting element.

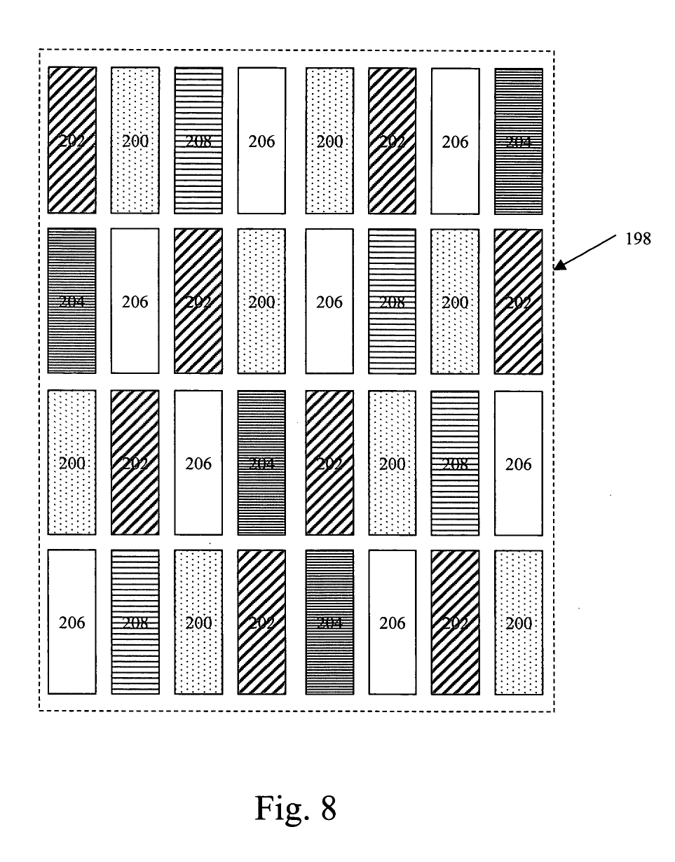

Although this disclosure provides an overview of the current invention, many modifications may be made that are within the scope of this invention. For example, there are many other arrangements of light-emitting elements for which this invention may be applied. FIG. 8 shows a portion of a display 198 having one more such arrangement of light-emitting elements, including red 200, green 202, blue 204, white 206 and cyan 208 light-emitting elements, wherein the white 206 and the cyan 208 light-emitting elements have a higher luminance efficiency than at least one of the red 202, green 200, or blue 206 light-emitting elements. As was the case for FIG. 3, each horizontal row and each pair of vertical columns of light-emitting elements contain all five colors of light-emitting elements.

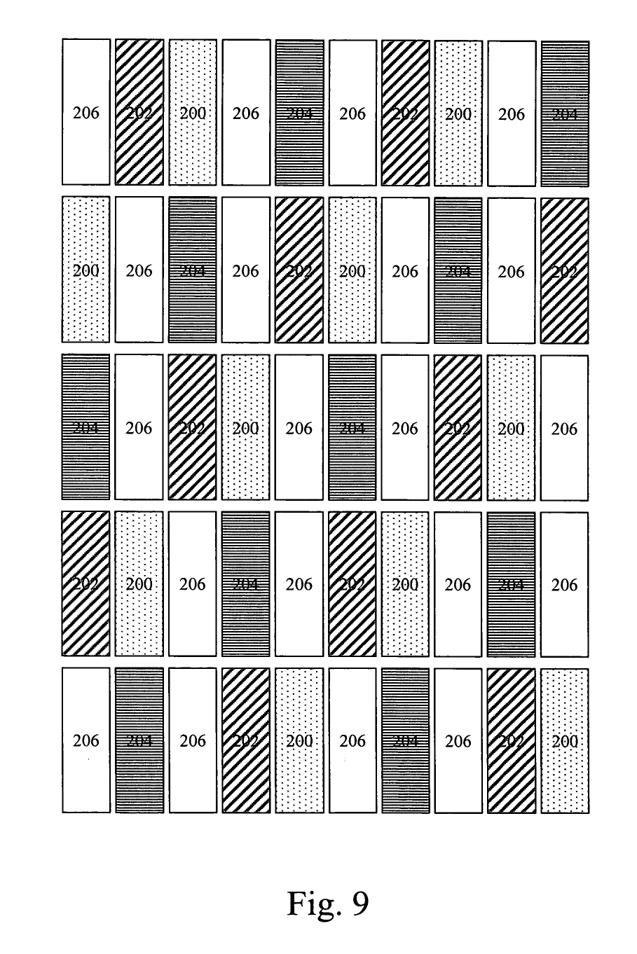

FIG. 9 depicts an additional arrangement of red, green, blue and white light-emitting elements, wherein the white 206 light-emitting elements are higher in luminance efficiency than at least one of the red 200, green 204 or blue 206 light-emitting elements. Although this arrangement of light-emitting elements contain the same colors of light-emitting elements as the arrangement depicted in FIG. 3 and each horizontal row and each pair of vertical columns of light-emitting elements contain all colors of light-emitting elements, this arrangement of light-emitting elements contains more white 206 light-emitting elements than red 200, green 202, or blue 204 light-emitting elements. Further, while the light-emitting elements shown in either of these figures and other figures throughout this disclosure are approximately equal in size, this is not required and the different color of light-emitting elements may be different in size. Further, any of these arrangements may contain unequal numbers of any color of light-emitting elements. However, it is likely that any arrangement of red, green, blue, and white light-emitting elements will contain more area of white light-emitting elements as these light-emitting elements will be used more often than the red, green, or blue light-emitting elements in most application and therefore, they will form a larger area of the display to balance the lifetime of the display device. Further, while the light-emitting elements are all depicted as being about twice as long in one dimension (i.e., the first dimension) than a second dimension, this is not required and the light-emitting elements may have any shape, including having a square shape.

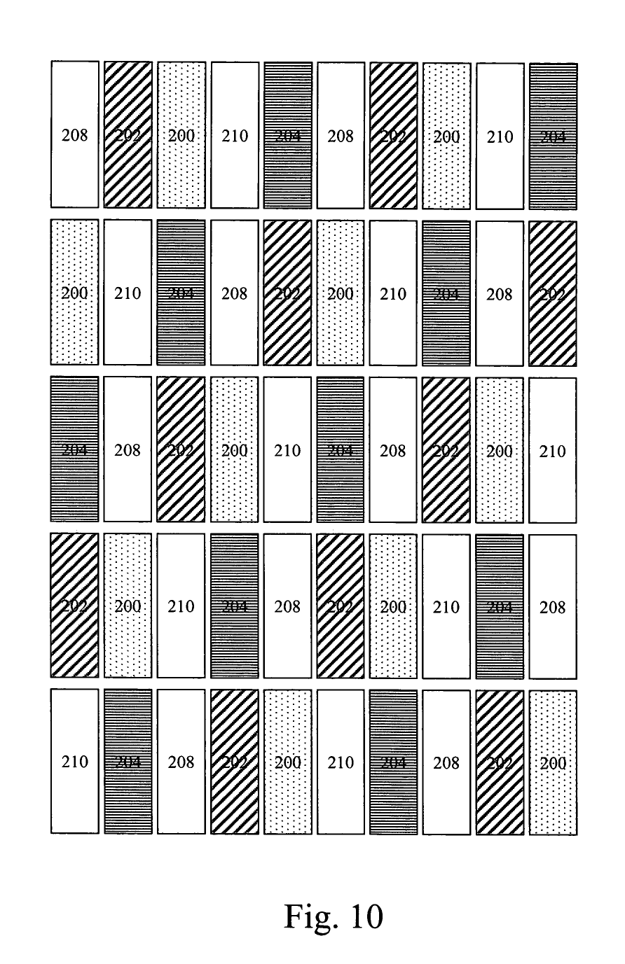

FIG. 10 depicts yet an additional arrangement of light-emitting elements, including red 200, green 202, blue 204, cyan 208 and yellow 210 light-emitting elements, wherein at the cyan 208 and yellow 210 light-emitting elements are higher in luminance efficiency than at least one and more preferably all three of the red 200, green 202, and blue 204 light-emitting elements. As in each of the embodiments each horizontal row and each pair of vertical columns of light-emitting elements contain all colors of light-emitting elements. It should be noted that in most applications, it is necessary to balance the lifetime of the emitters. For this reason, having additional yellow and cyan light-emitting elements can offset any color bias that the other introduces. Further, in systems employing color filters, it is highly desirable to add an unfiltered light-emitting element. Therefore, while many displays having five colors of light-emitting elements as shown in FIG. 10 may be desirable, it is most desirable to add combinations of yellow and cyan; white and yellow; or white and cyan to the red, green, and blue light-emitting elements to form a display having five colors of light-emitting elements.

Although this disclosure has been primarily described in detail with particular reference to OLED displays, it will be understood that the same technology can be applied to any electro-luminescent display device that produces light as a function of the current provided to the light-emitting elements of the display. For example, this disclosure may apply to electro-luminescent display devices employing coatable inorganic materials, such as described by Mattoussi et al. in the paper entitled “Electroluminescence from heterostructures of poly(phenylene vinylene) and inorganic CdSe nanocrystals” as described in the Journal of Applied Physics Vol. 83, No. 12 on Jun. 15, 1998, or to displays formed from other combinations of organic and inorganic materials which exhibit electro-luminescence.

The invention has been described in detail with particular reference to certain preferred embodiments thereof, but it will be understood that variations and modifications can be effected within the spirit and scope of the invention.

### PARTS LIST

2 luminance contrast threshold curve
4 red/green chrominance threshold curve
6 blue/yellow chrominance threshold curve
12 high-luminance subpixel
14 red subpixel
16 green subpixel
18 blue subpixel
40 display substrate portion
42 first row
44 second row
52 red light-emitting elements
54 green light-emitting elements
56 blue light-emitting elements
58 white light-emitting elements
60 first pair of columns
62 second pair of columns
72 blue light-emitting elements
74 white light-emitting elements
80 data line
82 select line
84 select transistor
86 capacitor
88 power transistor
89a capacitor line
89b capacitor line
90 power bus
92 power bus
94 semiconductor region
96 first electrode
108 power transistor gate
110 EL media
112 substrate
114 first dielectric layer
116 second dielectric layer
118 third dielectric layer
120 inter-subpixel dielectric layer
122 hole injecting layer
124 hole transporting layer
126 light-emitting layer
128 electron transporting layer
130 second electrode
132 light emission
140 controller
150 receiving step
152 buffering step
154 compute intermediate signal step
156 compute two-dimensional edge strength step
158 convert to four-or-more color signal step
160 input locations of light-emitting elements step
162 determine light-emitting elements step
164 down conversion step
170 first region
172 second region
174 boundary
198 display portion
200 red light-emitting element
202 green light-emitting element
204 blue light-emitting element
206 white light-emitting element
208 cyan light-emitting element
210 yellow light-emitting element

1. A full color electro-luminescent display system, comprising:
a display device comprised of a plurality of red, green, blue light-emitting elements and at least one additional color of light-emitting element having luminance efficiency greater than at least one of the red, green and blue light-emitting elements, each light-emitting element including a first electrode and a second electrode having one or more electro-luminescent layers formed there-between, at least one electro-luminescent layer being light-emitting, at least one of the electrodes being transparent and the first and second electrodes defining one or more light-emissive areas, wherein the light-emitting elements are laid out over a substrate in adjacent columns arranged along a first dimension and adjacent rows arranged along a second dimension, such that each pair of adjacent columns of light-emitting elements, and each row of light-emitting elements, contain each of the red, green, blue and additional color light-emitting elements; and
a controller for receiving an input signal for an input image having a two-dimensional spatial content including edge boundaries between first and second regions of the input image and driving the display, the controller being responsive to the two-dimensional spatial content of the input image whereby when the additional light-emitting elements are driven at different levels in the first and second regions of the input image, utilization of the light-emitting elements is adjusted such that the ratio of the sum of the luminance values of the red, green, blue light-emitting elements to the sum of the luminance values of the additional light-emitting elements along an edge boundary in at least one of the first and second regions is closer to one than the ratio of the sum of the luminance values of the red, green, blue light-emitting elements to the sum of the luminance values of the additional light-emitting elements within the interior of the at least one of the first and second regions within the displayed image, thereby increasing apparent display resolution while providing increased display power efficiency.

2. The full color electro-luminescent display system of claim 1, wherein the display device is additionally comprised of an active matrix circuit wherein power is provided by an array of electrical buses and wherein one or more of the electrical buses provide current to each color of light-emitting elements within the display device.

3. The full color electro-luminescent display system of claim 2, wherein the each pair of columns of light-emitting elements are arranged along each side of and are supplied power by a single electrical bus.

4. The full color electro-luminescent display system of claim 3, further comprising a controller for driving the light-emitting elements of the display device in combination to reduce the total current requirements of the buses by controlling the light emissive elements such that the luminance produced by at least one of the light-emitting elements, when all colors of light-emitting elements are employed simultaneously, is lower than the luminance that is produced by the same light-emitting element when the color of light that is being displayed is approximately equal to the color of the light-emitting element, reducing the peak current that each bus is required to provide.

5. The full color electro-luminescent display system of claim 2, wherein each row of light-emitting elements is supplied power by a single electrical bus, further comprising a controller for driving the light-emitting elements of the display device in combination to reduce the total current requirements of the buses by controlling the light emissive elements such that the luminance produced by at least one of the light-emitting elements, when all colors of light-emitting elements are employed simultaneously, is lower than the luminance that is produced by the same light-emitting element when the color of light that is being displayed is approximately equal to the color of the light-emitting element, reducing the peak current that each bus is required to provide.

6. The full color electro-luminescent display system of claim 1, wherein the at least one additional color of light-emitting elements light is white, cyan, yellow, or magenta.

7. The full color electro-luminescent display system of claim 1, wherein the length of each light-emitting element along the first dimension is more than 1.5 times the length of the light-emitting element along the second dimension.

8. The full color electro-luminescent display system of claim 1, wherein the length of each light-emitting element along the first dimension is approximately twice the length of the light-emitting element along the second dimension.

9. The full color electro-luminescent display system of claim 1, wherein the light-emitting elements are arranged in a repeating group of eight light-emitting elements, comprised of two adjacent rows of four light-emitting elements in a grid, wherein the four light-emitting elements in each row and in each pair of adjacent columns are comprised of different relative arrangements of red, green, blue and one additional colored light-emitting elements.

10. The full color electro-luminescent display system of claim 1, wherein the additional light-emitting elements are white light-emitting elements, and the light-emitting elements are arranged in repeating groups comprised of more white light-emitting elements than at least one of the red, green or blue light-emitting elements.

11. The full color electro-luminescent display system of claim 1, wherein the additional colored light-emitting elements include each of white and cyan, each of white and yellow, or each of cyan and yellow.

12. The full color electro-luminescent display system of claim 1, wherein the controller is responsive to the two-dimensional spatial content of the input image to adjust the utilization of the light-emitting elements by:
a. converting an RGB input signal for the input image to an intermediate signal;
b. calculating a two-dimensional edge strength with the intermediate signal by determining a ratio of a high frequency spatial filter to a low frequency spatial filter and summing the ratios for each spatial location in the input signal; and
c. converting the RGB input signal to a four-or-more color signal to drive red, green, blue and the one or more additional light-emitting elements that is dependent upon the edge strength at each spatial location.

13. The controller according to claim 12, wherein the intermediate signal is a luminance signal.

14. The controller according to claim 12, wherein the intermediate signal is a based on the minimum of the intensities of the R, G, B components of the RGB input signal at each spatial location.

15. The full color electro-luminescent display system of claim 12, wherein the controller additionally applies one or more spatial filters to one or more of the components of the four-or-more color signal.

16. The full color electro-luminescent display system of claim 1, wherein the areas of the differently colored light-emitting elements are not equal.

17. The full color electro-luminescent display system, wherein the light-emitting elements comprise organic light-emitting diodes.

18. A method for driving a full color electro-luminescent display system, comprised of a plurality of red, green, blue light-emitting elements and at least one additional color of light-emitting element, to display an image, the method comprising the steps of:
a. converting an RGB input signal for an input image to an intermediate signal that represents the utilization of the one or more additional light-emitting elements at each spatial location in the input signal;
b. calculating a two-dimensional edge strength with the intermediate signal by determining a ratio of a high frequency spatial filter to a low frequency spatial filter and summing the ratios for each spatial location in the input signal;
c. converting the RGB input signal based upon the edge strength at each spatial location to provide a four-or-more color signal to drive red, green, blue and the one or more additional light-emitting elements so that the ratio of the sum of the luminance values of the red, green, blue light-emitting elements to the sum of the luminance values of the additional light-emitting elements at spatial locations having a relatively high edge strength is closer to one than the ratio of the sum of the luminance values of the red, green, blue light-emitting elements to the sum of the luminance values of the additional light-emitting elements at spatial locations having relatively lower edge strength within the displayed image; and
d. Driving the display with the four-or-more color signal to display the image with increased apparent display resolution.

19. The method of claim 18, further comprising receiving a sampling lattice representing the sampling lattice of the display device, and wherein when the display has fewer light-emitting elements than the number of values in the four-or-more color signal, performing down conversion on the four or more color signal to provide a resulting signal that has fewer than the four or more color signals at each spatial location.

20. The method according to claim 18, wherein the conversion of the RGB image signal to a four or more color image signal comprises:
determining a minimum of the intensities of the R, G, B components of the RGB input signal at each spatial location;
subtracting at least a portion of the minimum from each of the intensities of the R, G, B components of the RGB image signal at each spatial location; and
forming the additional color signals as a function of the minimum of the intensities of the R, G, B components.
